(19) United States
(12) Patent Application Publication
(10) Pub. No.: US 2015/0166349 A1
(43) Pub. Date: Jun. 18, 2015

(54) METHOD FOR CONVERTING POLY(HYDRIDOCARBYNE) INTO DIAMOND-LIKE CARBON

(71) Applicants: Ian Booth, Sooke (CA); Peter G. Berrang, Saanichton (CA)

(72) Inventors: Ian Booth, Sooke (CA); Peter G. Berrang, Saanichton (CA)

(73) Assignee: Epic Ventures Inc., Saanichton, BC (CA)

(21) Appl. No.: 14/409,285

(22) PCT Filed: Jun. 19, 2012
(86) PCT No.: PCT/CA2012/000599

§ 371 Date: Dec. 18, 2014

(51) Int. Cl. C01B 31/06; C25B 1/00

(52) U.S. Cl. CPC C01B 31/06; C25B 1/00

(57) ABSTRACT

A low temperature method for converting poly(hydrocarbyne) into diamond-like carbon is based on removing pendant hydrogen using chemical or electrochemical means.

### FIELD OF THE INVENTION

The invention relates to the production of diamond or diamond-like carbon (DLC) coatings. In particular the invention relates to conversion of a poly(hydridocarbyne) (PHC) polymer coating into diamond or diamond-like carbon (DLC) coatings on surfaces.

### BACKGROUND OF THE INVENTION

Diamond and diamond-like carbon (DLC) coatings have great commercial utility for use as protective coatings, especially for electrode coatings, since such coatings can be doped to be electrically conductive, and are highly corrosion resistant even in strong oxidizing solutions in electrochemical applications with high overvoltage (see for example, M. Fryda, Th. Matthee, S. Mulcahy, A. Hampel, L. Schafter, I. Troster, Diamond and Related Materials, 12 (2003) (1950-1956).

Natural diamond is generally comprised of a cubic crystalline form of carbon. DLC, which is a mixture of mostly sp³-hybridized amorphous carbon, has some of the properties of diamond. Historically, DLC has been applied as a protective coating using a chemical vapour deposition (CVD) process, which process is expensive and limited to coating planar and relatively small, simple surface topographies.

Thus, the discovery by Patricia A. Bianconi, et. al. (J. Am. Chem. Soc., 2004, 126(10), 3191-3202) of the pre-ceramic precursor polymer poly(hydridocarbyne) (PHC) as a source material to form diamond and DLC coatings at atmospheric pressure and relatively low temperature pyrolysis represents a significant new class of material. PHC is a unique polymer which is a structural isomer of polyacetylene, but with a sp³-hybridized, tetrahedrally bound carbon network backbone comprised of [CH]ₙ. Each carbon must contain a hydrogen substituent, henceforth referred to as the pendant hydrogen, to prevent conversion to sp² carbon so as to minimize the ratio of sp² to sp³ bonded carbon. Thermal decomposition of PHC is achieved by heating PHC-coated substrates, or PHC powder, to temperatures in the range 600° C. to 1,100° C. in an inert atmosphere such as argon or nitrogen. This drives off the pendant hydrogen leaving carbon in the form of lonsdaleite, a hexagonal form of diamond, together with graphite. Typical substrates for PHC coatings are silicon, stainless steel or titanium, which materials are able to tolerate high temperature processing.

Removal of pendant hydrogen by UV irradiation at 248 nm has also been reported. The resultant material is a form of graphite, not specifically DLC. The use of such an UV irradiation process is limited to planar or simple topographic surfaces.

Poly(hydridocarbyne) (PHC) is an air-stable solid at room temperature that forms a nanoparticle or colloidal-dispersion in many polar organic solvents. This feature allows for simple, low cost “dip-coatings” of PHC-organic solvent solutions over large, complex surfaces, where said solution can be dried and heated to form adhesive diamond and DLC sub-micron to micron-thick corrosion resistant thin films or conformal coatings.

The properties of the resulting DLC depends on the amount of sp³ bonded carbon versus sp² bonding. DLC properties are also affected by the amount of residual hydrogen. Properties affected include hardness, chemical resistance, and electrical conductivity. Thus, there is great interest and utility in synthesizing PHC cost-effectively on a commercial scale.

Additionally, PHC can be used as a precursor material for synthesizing other materials such as, for example, graphite-like nanospheres (see S. Xu, X. B. Yan, X. L. Wang, S. R. Yang and Q. J. Xue, J. Mater. Sci. (2010) 45:2619-2624). The decomposition of PHC can also be used to increase the tensile strength in an exfoliated graphite matrix (see D. V. Savchenko, S. G. lonov and A. I. Sizov, Inorganic Mat. (2010) vol. 46 (2):132-138.

As carbon, diamond and DLC coatings are highly biocompatible, the application of DLC coatings over implants such as stents, eye and brain electrodes, cochlear devices, pacemakers, defibrillators, and hip, knee, etc. prosthetics is advantageous.

Other applications for DLC coatings include: coating frying pans to make them “non-stick”; applying electrically conductive DLC coatings over photovoltaic panels; coating glass and plastic surfaces to make them scratch resistant, and optionally, removing the coated substrate to make thin sheets of DLC glass; coating drill bits and earth-moving blades to make them wear-resistant; coating substrates to make them more heat-conductive; creating thin sheets of optically clear, hard diamond glass; coating surfaces such as boat hulls to make them anti-fouling; adding electrically conductive DLC “dust” to the paste used to form the NAM (negative active material) and PAM (positive active material) in lead-acid batteries; bonding DLC “dust” to paper or flexible substrates for use as abrasive sandpaper; adding DLC “dust” and or electrically conductive DLC “dust” to polymers used in the prior art of electrospinning of fibers, creating an DLC fiber.

DLC “dust” could also be used as a component in the feedstock for the high pressure high temperature (HPHT) process for growing monolithic crystalline diamond.

DLC coatings can be made electrically conductive by doping with, for example, nitrogen (i.e. see A. Zeng, E. Liu, S. N. Tan., S. Zhang, J. Gao, Electroanalysis 2002, 14, No. 15-16, pp. 1110-1115), boron (i.e. see M. Fryda, Th. Matthee, S. Mulcahy, A. Hampel, L. Schafer, I. Troster, Diamond and Related Materials 12 (2003) 1950-1956) or aluminum (i.e. see N. W. Khun, E. Liu, J. Nanoscience and Nanotechnology 2010, 10(7), pp 4767-4772).

U.S. Pat. No. 5,516,884 to Bianconi teaches the formation of 3-D tetrahedrally hybridized carbon-based random network polymers where elements such as silicon, germanium, tin, lead and lanthanides can be incorporated into the network backbone. Each carbon atom has one substituent and is linked via three carbon-carbon single bonds into a 3-D network of continuous fused rings. Thermal decomposition of such polymers forms diamond and DLC carbon. Typical decomposition temperatures are in the range 600 to 1,100° C. for a period of several hours.

Huang et. al. (S. M. Huang, Z. Sun, C. W. An, Y. F. Lu and M. H. Hong, 2001, J. App. Phy., 90(5), 2601-2605) use the reductive condensation of a 1,1,1-tricholorotoluene monomer with an emulsion of NaK alloy in tetrahydrofuran under inert atmosphere to synthesize poly(phenylcarbyne). They also provide data on using a pulsed UV laser for converting the poly(phenylcarbyne) to a diamond-like structure.

U.S. Pat. No. 6,989,428 to Bianconi, et al. provides a detailed summary of the prior art for polycarbyne ceramic polymers used to form diamond and diamond-like carbon.

Recent developments by Yusuf Nur et. al. (Yusuf Nur, Michael W. Pitcher, Semih Seyyidoglu and Levent Toppare, J. Macromolecular Science, Part A, 2008, 45(5), pp 358-363) and US Patent Application 2010/0063248 A1, describe a method for making PHC using the electrochemical polymerization of chloroform. Said approach is simpler, and potentially safer, than that given in U.S. Pat. No. 5,516,884 by Bianconi. Conversion to DLC was also achieved with high temperature (1,000° C.) exposure in an inert gas atmosphere.

PCT Patent Application No. PCT/CA2011/00134 by Berrang teaches a novel method for producing PHC whereby active material electrodes are immersed in a trihalomethane solvent (such as chloroform), and in conjunction with a low voltage electrical current, to produce PHC with minimal parasitic reaction byproducts.

The present invention overcomes the prior art limitations for the conversion of poly(hydridocarbyne) into DLC which rely on high processing temperature or simple topographic surfaces.

These and other objects of the invention will be better understood by reference to the detailed description of the preferred embodiment which follows. Note that not all of the objects are necessarily met by all embodiments of the invention described below or by the invention defined by each of the claims.

### SUMMARY OF THE INVENTION

The current invention describes low temperature chemical, ionized plasma and electrochemical techniques for removal of the pendant hydrogen from thin coatings of PHC on a substrate, or powdered PHC. Removal of this pendant hydrogen reduces PHC to DLC (sp³ bonded carbon) and graphite (sp² bonded carbon). The conversion methods are compatible with a variety of substrate materials and morphologies that would not be suitable for the application of DLC coatings by standard techniques. The methods described may also be used to convert PHC in powder form into diamond or DLC powder.

These techniques are useful in that they allow for the conversion of PHC on substrate materials not tolerant of high temperatures such as low melting point metals (e.g. aluminum), low melting point glasses or plastics.

The current invention also allows conversion of PHC that is coated onto convoluted or complex surfaces, such as reticulated foams.

The chemical conversion method involves exposing the surface of the PHC to liquid or gaseous chemicals that are selectively reactive with the PHC pendant hydrogen. The reaction products are dissolved or carried away from the surface of the PHC as gas or dissolve in the liquid.

Oxidizing agents for selectively removing the PHC pendant hydrogen include, for example, oxygen, ozone, chlorine and fluorine in liquid or gaseous form, as well as liquid oxidizers such as hydrogen peroxide and bleach.

Electrolytic methods according to the present invention for removing the PHC pendant hydrogen require that the PHC be coated on an electrically conductive substrate. According to this method, the PHC coated (conductive) substrate is immersed in a conductive electrolyte, typically an aqueous solution of an ionic salt or anionic species. A positive voltage is applied to the substrate relative to a counter electrode, which electrode is also in contact with the electrolyte. The resulting oxidizing environment at the positive electrode consumes pendant hydrogen atoms from the PHC.

Since PHC coatings are normally electrically insulating, the electrolytic method for removing the PHC pendant hydrogen requires the application of high voltages to force electrical current through the coating. Such high voltage may be applied in the form of short pulses to avoid excessive heating and dielectric breakdown of the PHC coating.

Alternatively the PHC may be doped with material to make it electrically conducting, such as a fraction of graphite powder. In this case continuous low voltages may be used.

Chemical and electrochemical processes involving liquid reactants can be enhanced by the addition of colloidal dispersions of catalytic materials such as platinum, palladium, nickel, silicon, titanium, tantalum, tungsten, molybdenum, neodymium, and iron to the liquid components.

In one aspect the invention comprises a method for converting poly(hydridocarbyne) (PHC) into diamond-like-carbon (DLC) comprising the steps of exposing said PHC to a chemical that is reactive with the pendant hydrogen in said PHC to produce DLC and reaction products and removing any excess of said chemical and said reaction products.

The chemical is a cryogenic liquid, a gas or an ionized gas that is reactive with hydrogen. In another aspect, it is an aqueous solution of an oxidizing chemical or an alkali metal.

The PHC on which the treatment is effected may be a coating on a substrate, said coating having a thickness between 100 nm and 10,000 nm, or a powder with particle sizes between 100 nm and 10,000 nm.

Where a cryogenic liquid is used, it may comprise ozone. In a more particular aspect of the invention, it comprises a mixture of ozone and at most 80% by weight of oxygen.

In another aspect, the cryogenic liquid contains a colloidal dispersion of a metallic catalyst and may further comprise oxygen, fluorine, chlorine, or nitrous oxide. In such case, the catalytic material may comprise one or more elements selected from the group comprising platinum, palladium, nickel, silicon, titanium, tantalum, tungsten, molybdenum, neodymium, iron.

Where a gas that is reactive with hydrogen is used, in another aspect of the invention, the gas may be ozone, oxygen, chlorine, fluorine or nitrous oxide. It may also be a mixture of two or more of said gasses. Preferably the temperature of the gas is between 25 and 200 degrees C.

In another aspect, where the chemical is an aqueous solution of an oxidizing chemical, the oxidizing chemical may be selected from the group comprising H₂O₂ (hydrogen peroxide) mixed with H₂SO₄ (sulfuric acid), H₂SO₄ (sulfuric acid), NaClO (bleach), HNO₃ (nitric acid), H₂SO₅ (Persulfuric acid), H₂CrO₄ (Chromic acid) or Dichromic acid (H₂Cr₂O₇), H₂O₂ (hydrogen peroxide) mixed with NH₄OH (Ammonium hydroxide). Preferably the temperature of the liquid is between 25 and 100 degrees C.

In another aspect, the liquid contains a colloidal dispersion of a catalytic material comprising one or more elements selected from the group comprising platinum, palladium, silicon, titanium, tantalum, tungsten, molybdenum, neodymium, nickel.

In another aspect, the catalytic material comprises particles with diameters in the range 20 to 100 nm at a concentration of substantially 1% by weight of said liquid.

Where the chemical is an ionized gas reactive with hydrogen, in one aspect of the invention, the gas is oxygen, chlorine, fluorine or hydrogen. In a further aspect, it may be ionized by an electrical discharge or by an electromagnetic field.

The gas pressure may be between 0.0001 and 0.01 atmospheres. In yet another aspect, the gas flows through the reaction volume so that the gas is substantially replaced over a period of between 10 to 1000 seconds.

In another aspect, the invention comprises a method for converting poly(hydridocarbyne) (PHC) into diamond-like-carbon (DLC) comprising the steps of:
coating said PHC onto an electrically conductive substrate;
immersing said PHC coated substrate in a liquid electrolyte;
applying a positive potential to said substrate relative to the surrounding electrolyte whereby to produce DLC and reaction products; and,
removing said electrolytes and said reaction products.

In another aspect, the conductive electrolyte is comprised of an aqueous solution of an anionic species. In a more particular aspect, the anionic species is selected from the following: Hydrochloric acid (HCl), hydrofluoric acid (HF), sulfuric acid (H₂SO₄), acetic acid (CH₃COOH), Nitric acid (HNO₃).

In another aspect, the positive potential applied to said substrate is in the range 2 to 10 volts and the PHC coating is electrically conductive.

The PHC coating may be made electrically conductive by doping with electrically conductive forms of carbon. Said electrically conductive forms of carbon constitutes one or more of: graphite, graphene, carbon nanotubes, carbon dust. In a further aspect the electrically conductive forms of carbon may constitute substantially 20% by weight of said PHC coating.

In another aspect, the positive potential applied to said substrate is in the range 100 to 1000 volts and said PHC coating is substantially electrically non-conductive. The PHC coating may have a thickness of between 100 and 10,000 nm. The positive potential may be pulsed with pulse length between 1 microsecond and 1 millisecond.

In another aspect, the conductive electrolyte contains a colloidal dispersion of a catalytic material. That material may comprise one or more elements selected from the group comprising platinum, palladium, silicon, titanium, tantalum, tungsten, molybdenum, neodymium, nickel. In an embodiment, the catalytic material comprises substantially 1% by weight of said conductive electrolyte.

Where the chemical is an alkali metal, in one aspect, the alkali metal is lithium, sodium or potassium. The alkali metal may be in the molten state and said PHC is immersed therein.

In another aspect, the alkali metal may be in the form of a colloidal dispersion in a carrier fluid and said PHC is immersed therein

The foregoing was intended as a summary only and of only some of the aspects of the invention. It was not intended to define the limits or requirements of the invention. Other aspects of the invention will be appreciated by reference to the detailed description of the preferred embodiments. Moreover, this summary should be read as though the claims were incorporated herein for completeness.

### DETAILED DESCRIPTION OF THE EMBODIMENTS OF THE INVENTION

In a first embodiment cryogenic liquid ozone is used as the reactant. The liquid ozone may contain a fraction of liquid oxygen preferably not exceeding 80% by weight. PHC in the form of a coating onto a substrate with a preferred coating thickness of between 100 and 10,000 nm., or alternatively a powder with a preferred particle diameter of between 100 and 10,000 nm, is immersed in the cryogenic liquid for a time period, following which the cryogenic liquid is allowed to evaporate leaving DLC in place of and in substantially the form of PHC. The time period is between 30 minutes and 4 hours, and generally increases in proportion to the thickness of the PHC coating or the particle diameter of the PHC powder. The maximum thickness of the PHC coating or the particle diameter is limited by the ability of the reactant to penetrate the PHC at cryogenic temperatures.

In a second embodiment cryogenic liquid mixed with a colloidal dispersion of a metallic catalyst is used as the reactant. The cryogenic liquid may comprise one of the following; oxygen, fluorine, chlorine, or nitrous oxide. The metallic catalyst may comprise one of the following; platinum, palladium, nickel, silicon, titanium, tantalum, tungsten, molybdenum, neodymium, or iron, and comprises preferably about 1% by weight of the reactant. PHC in the form of a coating onto a substrate with a preferred coating thickness of between 100 and 10,000 nm., or alternatively a powder with a preferred particle diameter of between 100 and 10,000 nm, is immersed in the cryogenic liquid for a time period, following which the cryogenic liquid is allowed to evaporate leaving DLC in place of and in substantially the form of the PHC. The time period is between 30 minutes and 4 hours, and generally increases in proportion to the thickness of the PHC coating or the particle diameter of the PHC powder. Following the evaporation of said cryogenic liquid residual amounts of catalytic metal may be removed by washing in water in the case of a DLC coated substrate, or by washing in water and filtering in the case of DLC powder.

In a third embodiment gas reactive with hydrogen is used as the reactant. The gas preferably comprises ozone which may contain a fraction of oxygen, preferably not exceeding 50% by weight of the gas. Alternately the gas may comprise one of the following; oxygen, fluorine, chlorine, or nitrous oxide. PHC in the form of a coating onto a substrate with a preferred coating thickness of between 100 and 10,000 nm., or alternatively a powder with a preferred particle diameter of between 100 and 10,000 nm, is exposed to the gas at substantially atmospheric pressure and an ambient temperature for a time period, following which the gas is vented to the atmosphere, leaving DLC in place of and in substantially the form of the PHC. The ambient temperature of the gas and PHC during exposure may be substantially room temperature (25C) or higher, up to 200C. The effect of increasing the ambient temperature during exposure is to reduce the time period required to effect the conversion of PHC to DLC. The time period is between 30 minutes and 24 hours, and generally increases in proportion to the thickness of the PHC coating or the particle diameter of the PHC powder, and decreases in proportion to increase in the ambient temperature.

In a fourth embodiment ionized gas reactive with Hydrogen is used as the reactant. The gas preferably comprises Hydrogen which in the atomic state binds strongly to hydrogen, alternately the gas may comprise one of the following; oxygen, fluorine, or chlorine. PHC in the form of a coating onto a substrate with a preferred coating thickness of between 100 and 10,000 nm., or alternatively a powder with a preferred particle diameter of between 100 and 10,000 nm, is exposed to the ionized gas for a time period, following which the gas is vented to the atmosphere, leaving DLC in place of and in substantially the form of said PHC. Exposure of the PHC to the ionized reactive gas is achieved as follows. The PHC is placed in a vacuum chamber with the reactant gas, which is evacuated to an ambient pressure of between 0.0001 and 0.01 atmospheres. The reactant gas flows through the reaction volume during said time period so that the gas is substantially replaced over a period of between 10 to 1000 seconds. The gas is ionized preferably by a radio frequency or microwave field such as in a microwave oven, alternatively a voltage may be applied between electrodes disposed within the vacuum chamber. The time period is between 5 minutes and 100 minutes, and generally increases in proportion to the thickness of the PHC coating or the particle diameter of the PHC powder.

In a fifth embodiment an aqueous solution of an oxidizing chemical is used as the reactant. The oxidizing chemical preferably comprises 30% H₂O₂ (hydrogen peroxide), mixed at a ratio of 1:3 by volume with H₂SO₄ (sulfuric acid), alternately H₂SO₄ (sulfuric acid), NaClO (bleach), HNO₃ (nitric acid), H₂SO₅ (persulfuric acid), H₂CrO₄ (chromic acid), dichromic acid (H₂Cr₂O₇), or 30% H₂O₂ (hydrogen peroxide), mixed at a ratio of 1:3 by volume with NH₄OH (ammonium hydroxide). Optionally a catalyst consisting of colloidal platinum, alternately palladium, silicon, titanium, tantalum, tungsten, molybdenum, neodymium, or nickel, with particle diameters in the range 20 to 100 nm may be mixed with the aqueous solution at a concentration of 1% by weight. PHC in the form of a coating on a substrate with a preferred coating thickness of between 100 and 10,000 nm, or alternatively a powder with a preferred particle diameter of between 100 and 10,000 nm, is immersed in the aqueous solution at an ambient temperature for a time period, following which the liquid is drained away leaving DLC in place of and in substantially the form of PHC. The ambient temperature may be substantially room temperature (25C) or alternatively between room temperature and 100C. The effect of increasing the ambient temperature during exposure is to reduce the time period required to effect the conversion of PHC to DLC. The time period is between 1 and 30 minutes and generally increases in proportion to the thickness of the PHC coating or the diameter of the PHC powder, and decreases in proportion to increase in the ambient temperature. Following the draining away of the reactant the produced DLC may be flushed with pure water to remove residual reactant and reaction products.

In a sixth embodiment electrolysis with an aqueous electrolyte solution is used as the reactant. PHC is coated onto an electrically conductive substrate with a preferred coating thickness of between 100 and 10,000 nm. A portion of the substrate is left uncoated to provide for an electrical connection. The coated portion of the substrate is immersed in an aqueous electrolyte at substantially room temperature, and exposed to voltage pulses of positive polarity for a time period, following which the substrate is removed from the electrolyte leaving DLC in place of and in substantially the form of the PHC. The aqueous electrolyte comprises a 5% solution of acetic acid (CH₃COOH), alternatively HCl, HF, H₂SO₄, or HNO₃. Optionally a catalyst consisting of colloidal platinum, alternately palladium, silicon, titanium, tantalum, tungsten, molybdenum, neodymium, or nickel, with particle diameters in the range 20 to 100 nm may be mixed with the electrolyte at a concentration of 1% by weight. The time period is between 1 and 10 hours and generally increases in proportion to the thickness of the PHC coating. The electrolyte and substrate are held in a vessel together with a counter electrode disposed within the vessel. Alternatively the vessel may itself be conductive and serve as a counter electrode. Voltage pulses are applied between the substrate and the counter electrode, with the substrate being positively charged with respect to the counter electrode to create an oxidizing environment in the vicinity of the PHC coating. Said voltage pulses have an amplitude of between 100 and 1000 V, with the preferred voltage generally increasing in proportion to the coating thickness. The high voltage is required to force current through the electrically insulating PHC coating. Each of the voltage pulses has a preferred time duration of 1 millisecond or less to avoid the effects of dielectric breakdown in the PHC coating. Said pulses are applied with a repetition rate such as to give an effective duty cycle of approximately 1%. For example pulses of 0.001 milliseconds duration and a repetition rate of 10,000 Hertz provide a 1% duty cycle.

In a seventh embodiment PHC is mixed with 20% by weight of carbon nanotubes and coated onto an electrically conductive substrate with a coating thickness of between 100 and 10,000 nm. The inclusion of carbon nanotubes provides electrical conductivity to the coating, alternately powdered graphite, grapheme, or carbon dust may be used in place of the carbon nanotubes. A portion of the substrate is left uncoated to provide for an electrical connection. The coated portion of the substrate is immersed in an aqueous electrolyte at substantially room temperature. The aqueous electrolyte comprises a 5% solution of acetic acid (CH₃COOH), alternatively HCl, HF, H₂SO₄, or HNO₃ Optionally a catalyst consisting of colloidal platinum, alternately palladium, silicon, titanium, tantalum, tungsten, molybdenum, neodymium, or nickel, with particle diameters in the range 20 to 100 nm may be mixed with the electrolyte at a concentration of 1% by weight. The electrolyte and substrate are held in a vessel together with a counter electrode disposed within the vessel. Alternatively the vessel may itself be conductive and serve as a counter electrode. The substrate is held at a positive potential of between 2 and 10 Volts relative to the counter electrode for a time period of between 1 and 10 hours. The positive potential voltage and time period are in general increasing in proportion to the coating thickness. The electrolyte, catalyst, and reaction products are subsequently drained away and the substrate flushed with water and dried in air leaving a coating of electrically conductive DLC in place of and in substantially the form of the PHC.

In an eighth embodiment an alkali metal in the molten state is used as the reactant. The alkali metal preferably comprises Li (lithium), alternately Na (sodium) or K (potassium). PHC in the form of a coating on a substrate with a preferred coating thickness of between 100 and 10,000 nm, or alternatively a powder with a preferred particle diameter of between 100 and 10,000 nm, is immersed in a bath of molten alkali metal under an inert gas such as Ar (argon). The temperature is sufficient to melt the alkali metal, approximately 180° C. in the case of Li, 100° C. in the case of Na, or 65° C. in the case of K. Reaction of the pendant hydrogen with the alkali metal forms alkali hydride and PHC is converted to DLC. The molten alkali metal is then drained away, or alternatively the DLC removed from the liquid metal. The reaction product consisting of the alkali metal hydride and any residual alkali metal is subsequently removed from the DLC by washing in water.

In a ninth embodiment an alkali metal powder is used as the reactant. The alkali metal preferably comprises Li (lithium), alternately Na (sodium) or K (potassium). The alkali metal is in the form of a powder with particle diameters in the range 20 to 100 nm dispersed in a carrier fluid such as mineral oil. PHC in the form of a coating on a substrate with a preferred coating thickness of between 100 and 10,000 nm, or alternatively a powder with a preferred particle diameter of between 100 and 10,000 nm, is immersed in the alkali metal dispersion. Reaction of the pendant hydrogen with the alkali metal forms alkali hydride and PHC is converted to DLC. The alkali metal and carrier fluid is then drained away, or alternatively the DLC removed from the fluid. Residual carrier fluid is removed from the DLC by washing in a solvent such as acetone. The reaction product consisting of the alkali metal hydride and any residual alkali metal is subsequently removed from the DLC by washing in water.

There have been described various specific approaches to effectively removing the pendant hydrogen from PHC to convert it to DLC and carbon.

In the foregoing specification, the invention has been described with reference to specific embodiments thereof. However, the scope of the claims should not be limited by the preferred embodiments set forth in the examples, but should be given the broadest interpretation consistent with the description as a whole. The specification and drawings are, accordingly, to be regarded in an illustrative rather than a restrictive sense.

1. A method for converting poly(hydridocarbyne) (PHC) into diamond-like-carbon (DLC) comprising the steps of exposing said PHC to a chemical that is reactive with the pendant hydrogen in said PHC to produce DLC and reaction products and removing any excess of said chemical and said reaction products.

2. The method of claim 1 wherein said chemical is a cryogenic liquid reactive with hydrogen.

3. The method of claim 2 wherein said PHC comprises a coating on a substrate, said coating having a thickness between 100 nm and 10,000 nm.

4. The method of claim 3 wherein said cryogenic liquid comprises ozone.

5-69. (canceled)

70. The method of claim 3 wherein said cryogenic liquid contains a colloidal dispersion of a metallic catalyst.

71. The method of claim 2 wherein said PHC comprises a powder with particle size between 100 nm and 10,000 nm.

72. The method of claim 71 wherein said cryogenic liquid contains a colloidal dispersion of a metallic catalyst.

73. The method of claim 1 wherein said chemical is a gas reactive with hydrogen.

74. The method of claim 73 wherein said PHC comprises a coating on a substrate, said coating having a thickness between 100 nm and 10,000 nm.

75. The method of claim 73 wherein the temperature of said gas is between 25 and 200 degrees C.

76. The method of claim 2 wherein said PHC comprises a powder with particle size between 100 nm and 10,000 nm.

77. The method of claim 76 wherein the temperature of said gas is between 25 and 200 degrees C.

78. The method of claim 1 wherein said chemical is an aqueous solution of an oxidizing chemical.

79. The method of claim 78 wherein said PHC comprises a coating on a substrate, said coating having a thickness between 100 nm and 10,000 nm.

80. The method of claim 79 wherein said oxidizing chemical is selected from the group comprising H₂O₂ (hydrogen peroxide) mixed with H₂SO₄ (sulfuric acid), H₂SO₄ (sulfuric acid), NaClO (bleach), HNO₃ (nitric acid), H₂SO₅ (Persulfuric acid), H₂CrO₄ (Chromic acid) or Dichromic acid (H₂Cr₂O₇), H₂O₂ (hydrogen peroxide) mixed with NH₄OH (Ammonium hydroxide).

81. The method of 80 wherein the temperature of said liquid is between 25 and 100 degrees C.

82. The method of claim 80 wherein said liquid contains a colloidal dispersion of a catalytic material comprising one or more elements selected from the group comprising platinum, palladium, silicon, titanium, tantalum, tungsten, molybdenum, neodymium, nickel.

83. The method of claim 82 wherein said catalytic material comprises particles with diameters in the range 20 to 100 nm at a concentration of substantially 1% by weight of said liquid.

84. The method of claim 78 wherein said PHC comprises a powder with particle size between 100 nm and 10,000 nm.

85. The method of 84 wherein the temperature of said liquid is between 25 and 100 degrees C.

86. The method of claim 1 wherein said chemical is an ionized gas reactive with hydrogen.

87. The method of claim 86 wherein said PHC comprises a coating on a substrate, said coating having a thickness between 100 nm and 10,000 nm.

88. The method of claim 87 wherein said gas is selected from the following:
oxygen, chlorine, fluorine, hydrogen.

89. The method of claim 88 wherein said gas is ionized by an electrical discharge.

90. The method of claim 88 wherein said gas is ionized by an electromagnetic field.

91. The method of claim 88 wherein the pressure of said gas is between 0.0001 and 0.01 atmospheres.

92. The method of claim 88 wherein said gas flows through the reaction volume so that the gas is substantially replaced over a period of between 10 to 1000 seconds.

93. A method for converting poly(hydridocarbyne) (PHC) into diamond-like-carbon (DLC) comprising the steps of:
coating said PHC onto an electrically conductive substrate;
immersing said PHC coated substrate in a liquid electrolyte;
applying a positive potential to said substrate relative to the surrounding electrolyte whereby to produce DLC and reaction products; and
removing said electrolytes and said reaction products.

94. The method of claim 93 wherein said conductive electrolyte is comprised of an aqueous solution of an anionic species selected from the following: hydrochloric acid (HCl), hydrofluoric acid (HF), sulfuric acid (H₂SO₄), acetic acid (CH₃COOH), Nitric acid (HNO₃).

95. The method of claim 93 wherein said positive potential applied to said substrate is in the range 2 to 10 volts and said PHC coating is made electrically conductive by doping with electrically conductive forms of carbon constituting substantially 20% by weight of said PHC coating.

96. The method of claim 93 wherein said positive potential applied to said substrate is in the range 100 to 1000 volts and said PHC coating is substantially electrically non-conductive.

97. The method of claim 96 wherein said positive potential is pulsed with pulse length between 1 microsecond and 1 millisecond.

98. The method of claim 1 wherein said chemical is an alkali metal.

99. The method of claim 98 wherein said alkali metal is in the molten state and said PHC is immersed therein.
